(19) United States
(12) Patent Application Publication
(10) Pub. No.: US 2014/0365253 A1
(43) Pub. Date: Dec. 11, 2014

(54) System for Calculating, Analyzing and Tracking Regulatory Recovery in a Relational Database relating to Regulatory Management

(71) Applicant: PowerPlan, Inc., Atlanta, GA (US)

(72) Inventors: Sarah E. Byers, Marietta, GA (US); William J. Cone, Marietta, GA (US); Jim Dahlby, Atlanta, GA (US); Alexander R. Elkin, Peachtree City, GA (US); Mark Heinemann, Davidson, NC (US); Aaron James Smith, Roswell, GA (US); Timothy D. Zeldenrust, Winfield, IL (US)

(73) Assignee: PowerPlan, Inc., Atlanta, GA (US)

(21) Appl. No.: 14/279,670

(22) Filed: May 16, 2014

Related U.S. Application Data
(60) Provisional application No. 61/824,772, filed on May 17, 2013.

(51) Int. Cl. G06Q 30/00; G06Q 10/06

(52) U.S. Cl. CPC G06Q 30/018; G06Q 10/063
USPC 705/7.11

(57) ABSTRACT

A system for calculating, analyzing and tracking regulatory recovery relating to regulatory management has been developed. The system includes, a mapping interface for mapping the source data from multiple source databases, analysis keys that are applied and act as data tags to the mapped source data and a storage database for storing the mapped source data. A jurisdictional template is used for filtering mapped source data in order to model the data for a specific jurisdiction. Next, a case ledger layer that generates rate cases based on filtered mapped source data. A regulatory monitoring tool is then used to monitor regulatory recovery performance. Finally, a revenue requirements manager that analyzes both historical and forecast rate cases generates a user report.

### CROSS-REFERENCE TO RELATED APPLICATIONS

This application claims priority from U.S. Provisional Application No. 61/824,772 titled “SYSTEM FOR ENSURING COHERENCY IN A RELATIONAL DATABASE RELATING TO ASSET MANAGEMENT” that was filed on May 17, 2013.

### FIELD OF THE INVENTION

The present invention relates generally to computer software. More specifically, the present invention relates to a system for calculating, analyzing and tracking regulatory recovery in a relational database relating to regulatory management.

### BACKGROUND ART

Certain industries, such as transportation, telecommunications, and utilities, are asset-intensive and financially complex. Companies in these industries must comply with a vast number of requirements, from both a jurisdictional and regulatory perspective, while performing extremely complex accounting procedures. In addition, the tax calculations and revenue requirement analyses for companies in these industries can become unwieldy due to multifaceted jurisdictions and large amounts of assets.

Certain capabilities currently exist, but typically involve tedious calculations and increase the risk of human error. Due to these complications, a need exists for a system that streamlines the accounting process while providing the capability to maintain records and incorporate regulatory changes.

### SUMMARY OF THE INVENTION

In some aspects, the invention relates to a system for calculating, analyzing and tracking regulatory recovery relating to regulatory management, comprising: a mapping interface for mapping the source data from multiple source databases; analysis keys that are applied and act as data tags to the mapped source data; a storage database for storing the mapped source data; a jurisdictional template for filtering mapped source data in order to model the data for a specific jurisdiction; a case ledger layer that generates rate cases based on filtered mapped source data; a regulatory monitoring tool that monitors regulatory recovery performance; a revenue requirements manager that analyzes both historical and forecast rate cases; and a user report generated from the regulatory monitor and revenue requirements manager.

In other aspects, the invention relates to a method for calculating, analyzing and tracking regulatory recovery relating to regulatory management, comprising: mapping source data from multiple source databases with a mapping interface; applying analysis keys to the mapped source data, where the analysis keys act as data tags; storing mapped source data in a storage database; filtering the mapped source data through a jurisdictional template to model the data for specific jurisdictional considerations; creating a separate rate case from the filtered data with a revenue requirements manager; and compiling a user report on the accounts from the separate rate case.

Other aspects and advantages of the invention will be apparent from the following description and the appended claims.

### BRIEF DESCRIPTION OF DRAWINGS

It should be noted that identical features in different drawings are shown with the same reference numeral.

FIG. 1 shows a diagram of the work flow of a tax calculation system in accordance with one embodiment of the present invention.

FIG. 2 shows a diagram of the work flow of a relational database in accordance with one embodiment of the present invention.

FIG. 3 shows a diagram of the work flow of a database asset record in accordance with one embodiment of the present invention.

FIG. 4 shows a diagram of the work flow of calculation engines in accordance with one embodiment of the present invention.

FIG. 5 shows an example of a tax status process in accordance with one embodiment of the present invention.

FIG. 6 shows a diagram of the relationship between a database asset record and tax unit of property at the testing level in accordance with one embodiment of the present invention.

FIG. 7 shows an example of a tax expense calculation process in accordance with one embodiment of the present invention.

FIG. 8 shows an example of the organization of foundational data used in tax calculations in accordance with one embodiment of the present invention.

FIG. 9 shows a diagram of the workflow of a regulatory system in accordance with one embodiment of the present invention.

FIG. 10 shows a diagram of the workflow of a case ledger layer in accordance with one embodiment of the present invention.

FIG. 11 shows an example of a visual allocator in accordance with one embodiment of the present invention.

### DETAILED DESCRIPTION

A system for calculating, analyzing and tracking regulatory recovery in a relational database relating to regulatory management has been developed. It should be understood that calculations performed by the present invention may be applied to a broad range of industries, including but not limited to utilities, transportation, oil & gas, mining, and telecommunications. The present invention provides the capability to perform complex accounting tax and regulatory calculations with regard to accounting and regulatory management, while maintaining statutory and regulatory requirements. Additionally, the present invention provides the capability to modify data repositories based on calculations performed to allow for updated record keeping and accurate future calculations. Features of the system include: the ability to create account data within the system; an interface between original account data and specialized file formats; a file indexing system and storage database; automated location data; automated retirement determinations; multiple calculation engines; audit reports; tax depreciation forecasts; the ability to update account data; and interfaces with other calculation modules. It should be understood that the term “account” is broadly defined to mean assets (both tangible and intangible), revenues, expenses, liabilities and any other suitable categories of items for entry into a financial balance sheet, income statement or similar accounting document.

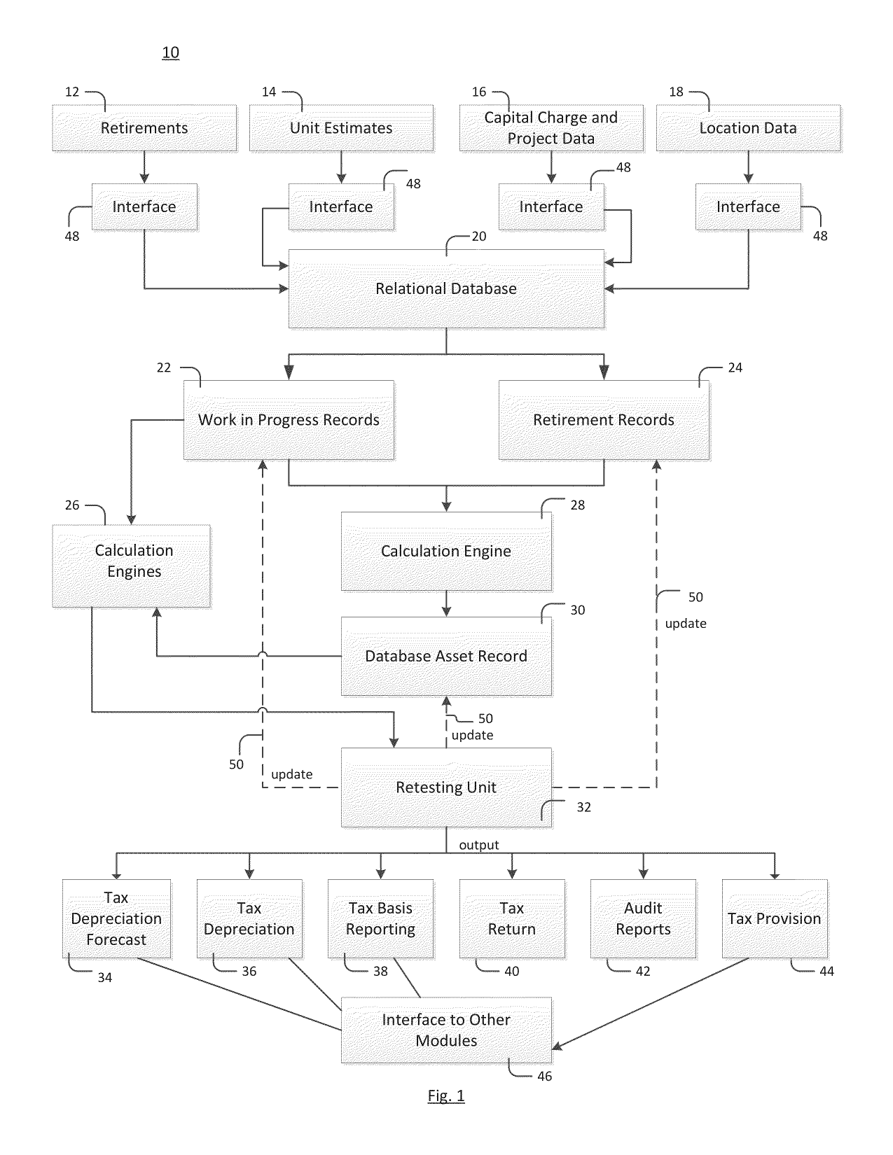

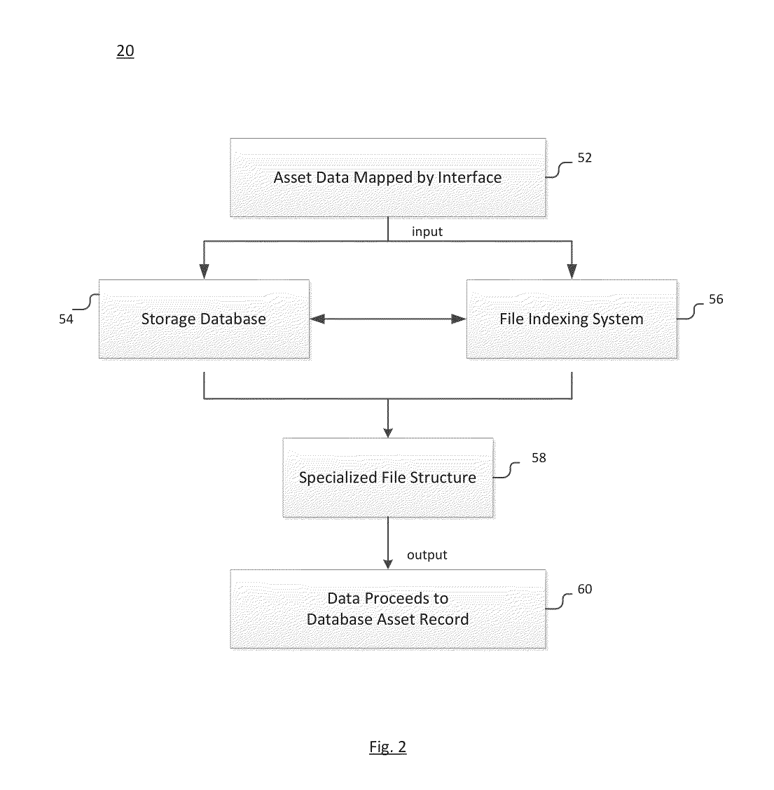

FIG. 1 shows a diagram of the overall functionality and work flow of a tax calculation system 10 in accordance with one embodiment of the present invention. In this embodiment, original asset data is provided separately by several sources, including retirements 12, unit estimates 14, capital charge and project data 16, and location data 18. Each of these sets of original data is mapped through a mapping interface 48 and sent to a relational database 20, which is more fully described below and shown in FIG. 2. The relational database 20 then supplies the asset data in a new file format to the work in progress records 22 and retirement records 24, described in further detail below. The work in progress records 22 and retirement records 24 each output data into the retirement calculation engine 28. In addition, the work in progress records 22 provide data to the calculation engines 26.

The retirement calculation engine 28 supplies data to the database asset record 30, which in turn provides data to the calculation engines 26. The structure shown in this embodiment with regard to the calculation engines 26 and the database asset record 30 provides a significant advantage by allowing testing as charges accrue on a project, even before an asset is created. Retesting is then performed by the retesting unit 32 to determine whether further calculations are needed. If no additional calculations are needed, the system provides data output in the form of several reports, including tax depreciation forecasts 34; tax depreciation 36; tax basis reporting 38; tax return 40; audit reports 42; and tax provision 44. Data from the retesting unit is also used to retroactively update 50 the work in progress records 22, the retirement records 24, and the database asset record 30 in order to allow for more accurate future calculations. Furthermore, the ability of the tax calculation system 10 to retroactively update 50 various databases maintains coherency and consistency throughout the database records. Finally, the system provides the capability to interface the output with alternate calculation modules via the module interface 46. These tests and calculations may be performed at an accounting level or individual operational level.

FIG. 2 shows a diagram of the work flow of a relational database 20, as shown in FIG. 1, in accordance with one embodiment of the present invention. In this example, the relational database 20 includes both a storage database 54 and a file indexing system 56 that may be directly linked. When mapped asset data 52 is inputted into the relational database 20, it may be both indexed and stored until calculations are needed. Specialized file structures 58 or formats may be used within the relational database 20 or throughout the entire system.

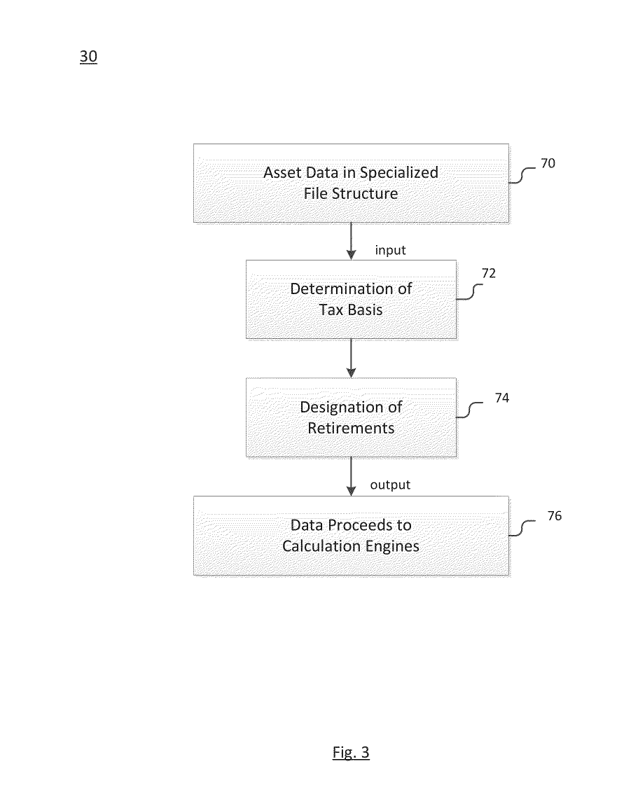

FIG. 3 shows a diagram of the work flow of a database asset record 30, as shown in FIG. 1, in accordance with one embodiment of the present invention. In this example, the retirement calculation engine output data 70 is sent to a database asset record 30, which first makes a determination of tax basis 72. Additions and retirements are obtained from the relational database 20, which then allows the database asset record 30 to determine, for each asset, whether it was deducted in previous years. After a determination is made, the database asset record 30 marks the prior retirements with a specific designation 74. These designated assets continue through the system, but are included only in certain calculations and excluded from others.

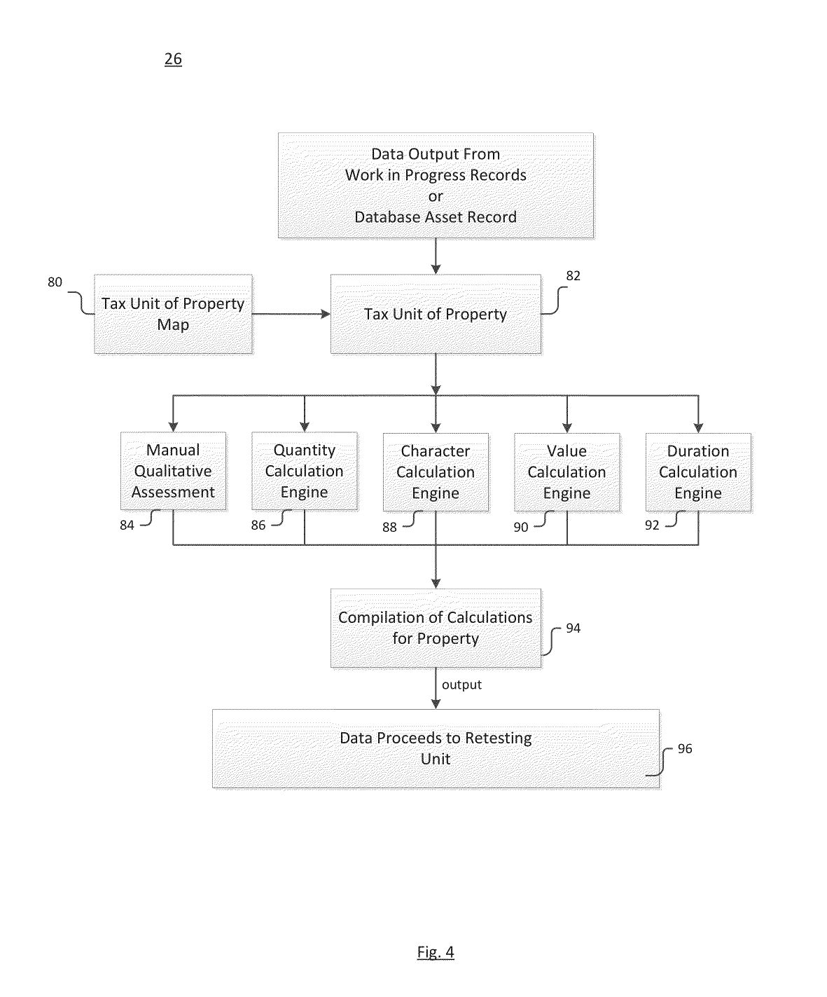

FIG. 4 shows a diagram of the work flow of a collection of calculation engines 26, as shown in FIG. 1, in accordance with one embodiment of the present invention. In this example, database asset record output data 76 and the tax unit of property map 80 supply data to determine the tax unit of property 82. The tax unit of property 82 data then proceeds to individual calculation engines, and there may be multiple calculation engines to test for separate items. In this embodiment, there are four calculation engines to test for each of quantity 86, character 88, value 90, and duration 92. In addition, a manual qualitative assessment may be performed 84 at this stage for verification of user-designated factors. These calculation engines 26 determine which assets are currently deductible and which must be capitalized. Multiple methods for testing may be used, and multiple methods may be processed simultaneously. Once calculations are performed, the data from calculation engines may be compiled 94 with regard to each asset.

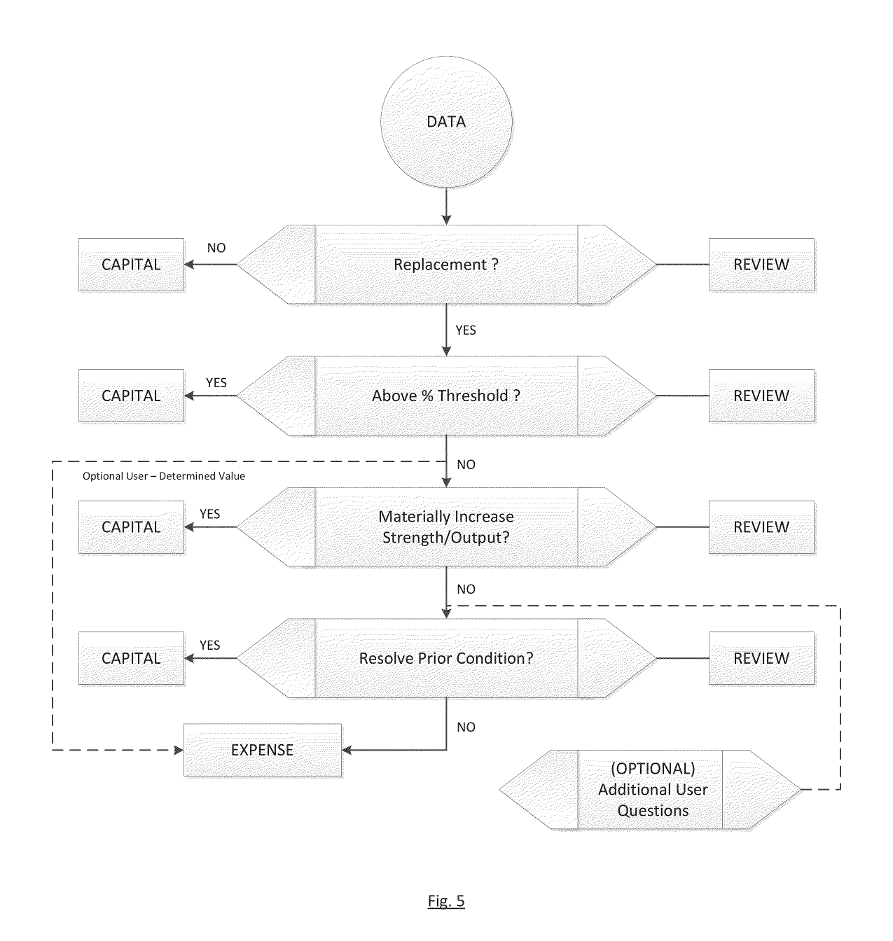

FIG. 5 shows one example of a tax status process in accordance with one embodiment of the present invention. In this example, a user may configure the system to perform a series of inquiries with regard to an asset. Based on user input and regulatory requirements, the system determines whether an asset qualifies as an expense, or whether it must be capitalized. Review may be available at any stage during the process.

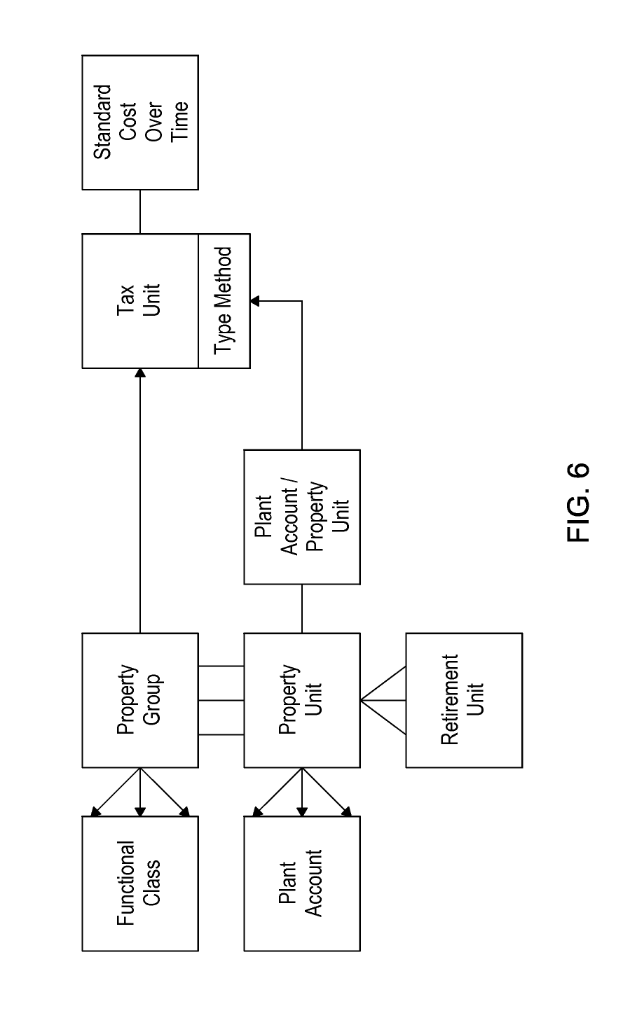

FIG. 6 shows a diagram of the tax unit of property map 80, as shown in FIG. 4, in accordance with one embodiment of the present invention. This diagram illustrates the relationship between a database asset record 30 and tax unit of property 82 at the testing level. In essence, this diagram demonstrates one example of a structure used to map book assets to a tax unit of property 82.

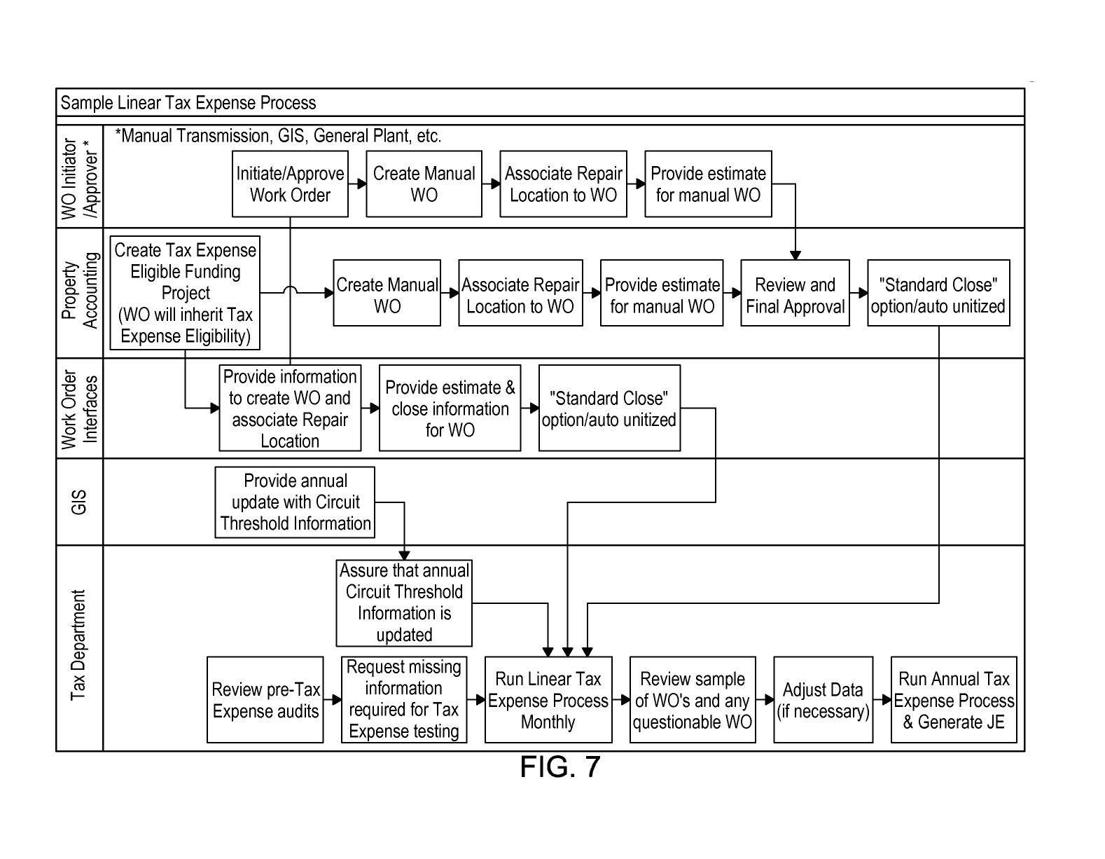

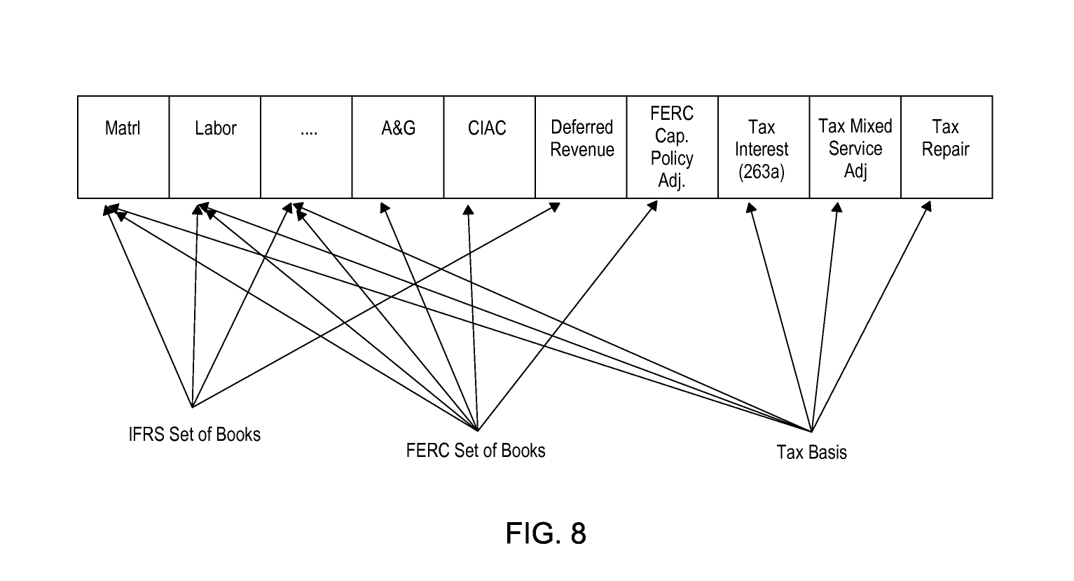

FIG. 7 shows one example of a tax expense analysis process in accordance with one embodiment of the present invention. FIG. 8 shows one example of the organization of foundational data used in tax calculations in accordance with one embodiment of the present invention. In this example, costs used for tax calculations are organized into basis categories. These basis amounts may be maintained and updated for more accurate calculations.

There are three central architectural features of the system of one embodiment of the present invention: a regulatory database; a case engine; and a presentation system. These controls are not only built into any database features, but they are present throughout the system including, importantly, the case engine. In addition, there are automatic alerts and tracking to assist the user. For example, adjustments potentially impacting another calculation trigger a warning.

The regulatory database, composed of historic and forecast ledgers, and certain statistical data, is not a passive repository, but may deliver controlled integration to the general ledger, outside forecasting sources, other source (e.g., for allocation factors), back and forth to spreadsheets, and all CWIP, Asset, and Tax Modules. Historic actual. and forecast financial data is kept at a user-defined regulatory account level of detail by month. The database has reconciliation routines with the tracking of any reclasses necessary, dynamic regulatory account generation, complete drill back facilities for research and explanatory power, and analytics for tracking anomalies and trends.

Much of the required data, both actual and forecast, to support rate cases, monitor returns, and analyze accounting and processes impacting regulatory recovery is already in other sources. This data includes: asset balance and asset activity detail; depreciation expense and accumulated reserve detail; deferred tax detail; tax detail; CWIP, CWIP in rate base, and CWIP related deferred taxes; capital rider balances and information; property tax detail; operations, maintenance, general, administrative, and other costs through the charge repository (CR), with detailed drill back to source documents; and capital and operations and maintenance budgets and corresponding forecasts of plant-in-service, depreciation, tax depreciation, deferred taxes, property taxes, operating and maintenance costs, and overheads. Embedded in this forecast capability is robust logic for overheads, carrying costs, depreciation and taxes. This data can be integrated from other budget and forecast systems as well via delivered external source API's.

Thus the data within the regulatory system includes: historical accounting data (maintained at a regulatory account level with drill back to actual and for balance sheet items roll forward activity as well as balances are maintained); budget, outlook, and forecast data (similar to historic); allocation statistics and factors, and other statistical data (e.g., billing factors); and case histories, including adjustments and case result histories.

The system has the unique ability to generate regulatory accounts from applications including the CR., CWIP, Asset, Depreciation, Income Tax, and Deferred tax data using a flexible ‘member’ and ‘component’ concept. For example, the user can designate a depreciation group or set of groups as a member in the depreciation family and then designate any depreciation attributes, e.g., depreciation expense, reserve, salvage, retirements, gain/loss, etc. to build the components they desire. Then the system automatically sets up regulatory accounts based on the combination of depreciation members and components and automatically extracts and balances them each month to the historic ledger or the forecast ledger.

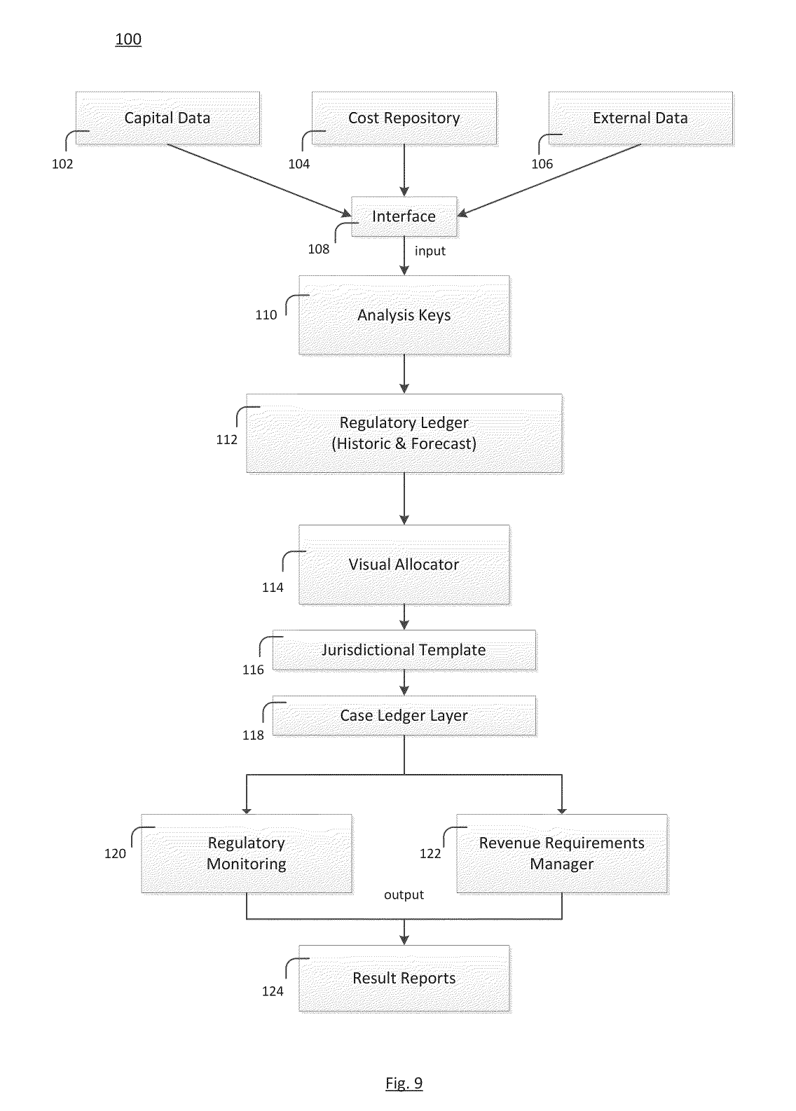

FIG. 9 shows a diagram of the workflow of a regulatory system 100 in accordance with one embodiment of the present invention. In this embodiment, data is originally stored in several databases. The charge repository 104 provides a collection of past financial transactions and related information, as well as a record of operating and maintenance expenses. Data from the charge repository 104 is mapped through an interface 108 before proceeding to other portions of the regulatory system 100. The capital database 102 may contain information regarding various projects, assets, and previously determined tax or depreciation information. In addition, this embodiment allows the regulatory system 100 to utilize data from other external databases 106. Data from the capital database 102 and any external databases 106 is mapped through an interface 108 before proceeding to other portions of the regulatory system 100.

Once data is mapped through the interface 108, analysis keys 110 are applied to the data based on user-determined criteria. The analysis keys 110 are able to intelligently summarize data based on previously defined characteristics set by the user. As a result, the analysis keys 110 act as data tags which are attached to the data for the remainder of the workflow in the regulatory system 100. After analysis keys 110 are applied to data, the data is stored in the regulatory ledger 112. The regulatory ledger 112 is a primary database which may contain both historical (actual) information and forecast information.

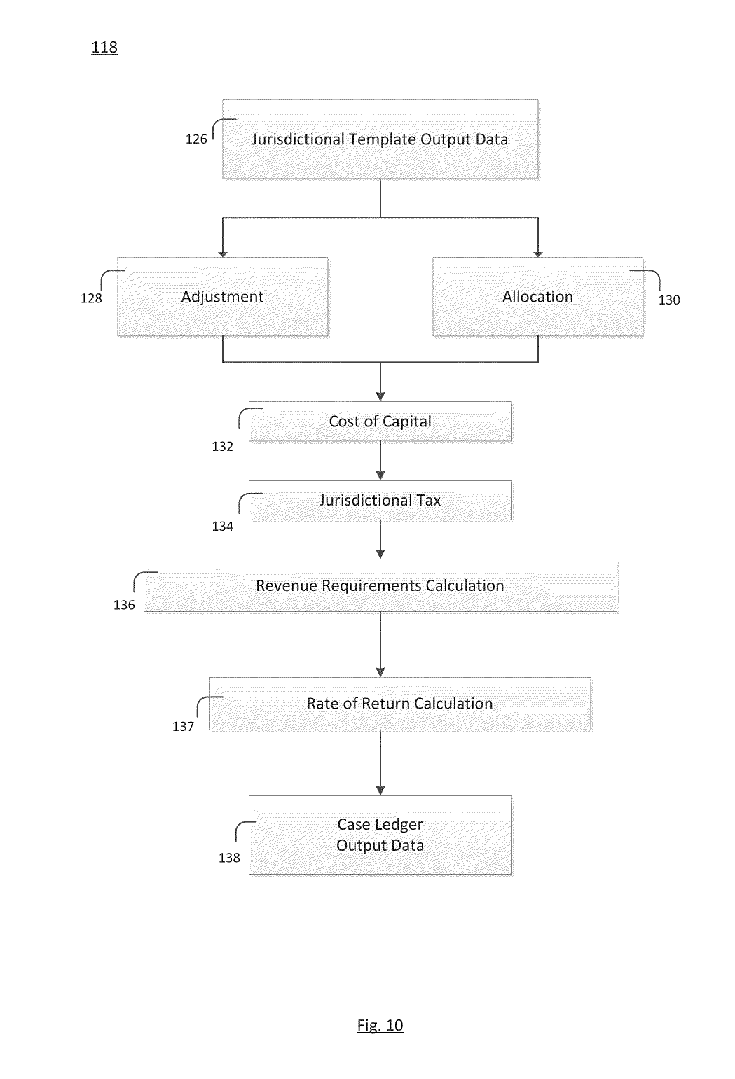

The visual allocator 114 is a tool that allows the user to graphically represent and configure data in an unlimited number of scenarios for allocation and analysis. Allocation rules used in the jurisdictional template 116 and case ledger layer 118 are based on the user's decisions in the visual allocator 114. The jurisdictional template 116 is a filter which the data in the regulatory ledger 112 is put through in order to model a specific jurisdiction. Specifically, the jurisdictional template 116 provides the ability to recognize and configure data based on jurisdictional requirements. The jurisdictional template 116 filters data for later calculations and does not perform any calculations itself; however, there may be user determined overrides to the configuration set forth by the jurisdictional template 116 filter. The case ledger layer 118 provides the regulatory system 100 with the ability to create, manage, and analyze separate cases, as more fully described below and shown in FIG. 10.

The regulatory monitoring tool 120 provides a variety of monitoring functions, including monthly comparison views, projected regulatory results, and updated financial allocation reports. The revenue requirements manager 122 utilizes data from the case ledger layer 118 to allow the user to manage known and measurable adjustments, calculate, analyze and track both forecast and historical rate cases. Finally, both the regulatory monitoring tool 120 and revenue requirements manager 122 may provide final result reports 124 for the user's benefit and records.

The case engine can be used for management monitoring, commission surveillance reporting, actual rate case development and filings, clause or segment analysis and comparison, and policy analysis. Management monitoring includes: analyzing (monthly) regulatory 12 month ended returns compared to financial returns earned; current results in regulatory format vs. last settled or last filed results for leakage explanation; multi jurisdictional recovery cracks or seams; regulatory returns of current outlooks or forecasts; historic tracking of years through time starting as a forecast then budget, and finally actual; effectiveness of clause recoveries and impacts on total returns. Return on equity impacts can be for each adjustment and separation. Cases can be multiyear including a mix of historic, partially historic, and budget or forecast years. The methods and options are user-driven, defaulted from jurisdictional templates, including standard adjustments and separation methodologies. Case options may be different for monitoring than for actual rate cases and alternative methodologies can be used as scenarios in a single rate proceeding or analysis.

Adjustment processing is another principal feature of the case engine. Adjustments may be made or generated for historic or forecast years. These adjustments can be for known and measurable items, normalizing outlier results, disallowances, substitutions (e.g., work capital allowance different from the financial balance sheet), different accounting methodology (e.g., financial capital lease vs. regulatory operating lease), pension/post retirement treatments, or forecast project assumptions. Adjustments are taken through all levels of the separation, so that their impact can be reported against the results measured both in dollars and equity returns from total company to jurisdictional to class costs of service levels.

Separations between utility/non-utility, multiple jurisdictions (each with its own methodologies), between base rates and clauses, or customer classes of services is a main feature of the case engine. Separations may be jurisdictionally defined, and are specified by the user graphically employing categories and targets. For example, the first allocation category may split out non-utility operations, the next category could split out services (e.g., gas and electric), the next category could allocate to functions (e.g., distribution, transmission, and generation), and the next could split state jurisdictions or the FERC. Class cost of service separations can follow. The system can perform the allocations at a low level, allows for specific assignments or partial assignments, and factors can be calculated dynamically, and based on other separation results.

By being linked directly with the rest of system of the present invention, many adjustments can be calculated automatically. For example, the system can automatically calculate an adjustment from old to new depreciation rates including the impact on deferred taxes. Similarly, the system can automatically set up and calculate an adjustment associated with a forecast project revision including all the impacted accounts such as CWIP, Plant-in-Service, and Regulatory Accounts if any, Depreciation, Reserve, Deferred Taxes, and Property Taxes. And the system employs the same computations as actual so that no variance is introduced by different methodology.

Importantly, the system of the present invention calculates the income taxes associated with each separation and adjustment. These computations can encompass multi-state impacts, special non-statutory items like flow through or excess deferred taxes and non-statutory ARAM rates, federal and state credits, permanent items, and, of course, interest synchronization. By direct integration with related tax modules all balances, elections and methods are consistent and up-to-date. Taxes can be reconciled with actual recorded financial taxes. For revenue requirements the user can use a revenue deficiency methodology or an equity return gross up methodology.

The system can use an actual capital structure (with adjustments), a theoretical capital structure, and calculated or input rates (e.g., the long term debt rate could be calculated, but a short term rate might be input). The components of the capital structure are defined by the user by jurisdiction, with individual adjustments defined in the cases. For example, one jurisdiction could include accumulated deferred taxes in the cap structure and another might not, treating them as a rate base deduction. Interest synchronization can be determined from a subset of the capital structure; and the capital structure can also be synchronized with the rate base.

FIG. 10 shows a diagram of the workflow of a case ledger layer 118, as shown in FIG. 9, in accordance with one embodiment of the present invention. The case ledger layer 118 utilizes jurisdictional template output data to determine which data from the regulatory ledger 112 will be put into a rate case. Once this determination is made, the case ledger layer 118 performs company adjustments 128 and jurisdictional allocations 130 based on the jurisdictional template output data 126. These company adjustments 128 and jurisdictional allocations 130 may be previously set by the user. Cost of capital 132, jurisdictional tax 134, revenue requirements calculations 136, and rate of return calculations 137 may be applied to the rate case if applicable, as determined by the user. More than one iteration may be performed within the case ledger layer 118 if needed. Finally, the case ledger output data 138 is used to create a specific rate case.

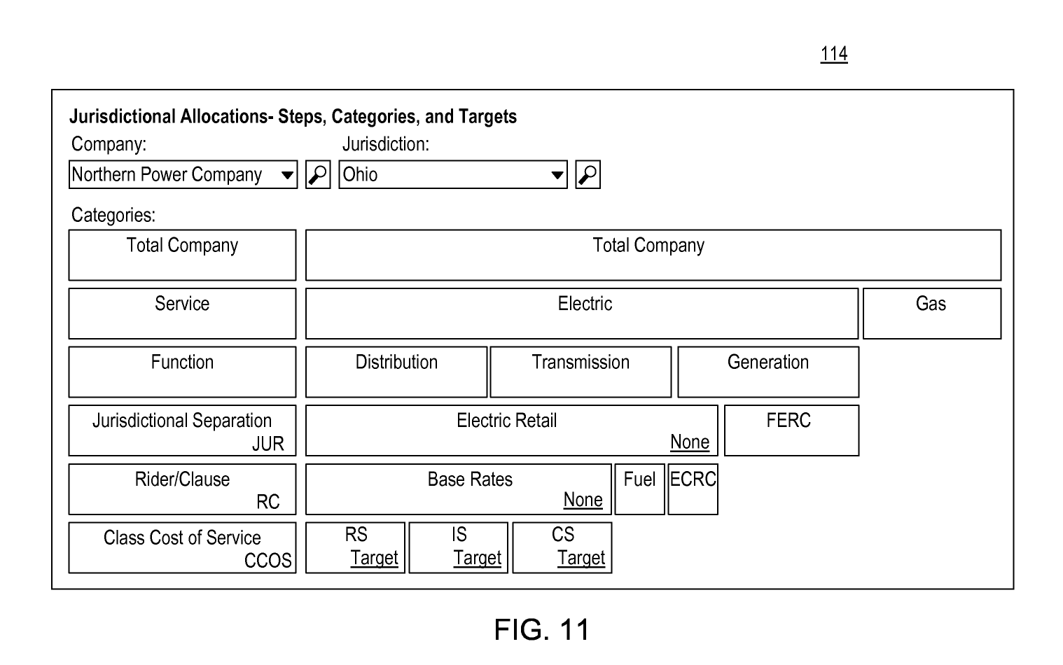

FIG. 11 shows an example of a visual allocator 114, as shown in FIG. 9, in accordance with one embodiment of the present invention. As noted above, the visual allocator allows a user to graphically configure settings and attributes which are used throughout the regulatory system 100.

The system provides user security over the different functions and screens in the case, tracks all updates by users, and visually alerts users to logically incomplete results, such as the introduction of a late adjustment which had not been run through all the separation and results analysis. Multiple cases can be worked on at the same time, and multiple people can work on the same case at the same time. For example, you can have a person working on allocations while another is working on adjustments, or two people can both be working on adjustments. One process does not have to be complete before another is begun or run on a test basis. Cases are saved, including all adjustment and allocation calculations. Cases can be copied in whole or part. When a case is filed, it can be locked and then no further updates are allowed. These are all part of the case management process.

The users review and analyze results through visually intuitive graphics, work spaces with drill backs, and reports. A click on a line item on one report can open another explaining that item in terms of detail or computation. Visual analysis using predefined charting presentations are available, for example, a ‘Waterfall’ graph of the positive and negative adjustment impacts on revenue requirements or earnings. Account balance trending and comparison over time on the regulatory ledger or within a case can be performed. Extracts to support specific MFRs can be quickly established or modified

An additional system feature may include the capability to extract data from the relational database and transform the data through another interface. The transformed data may have appended regulatory attributes in addition to the general attributes. The original relational database may not be updated with these regulatory attributes; instead, an additional layer of storage may be created. The present invention may provide the capability for a user to input any number of jurisdictional templates, which will include regulatory treatment for assets and activities according to varying states, municipalities, or regions. Additionally, a user may create any number of rate cases, which may inherit logic from the jurisdictional templates.

Some jurisdictions may contain specific requirements for the treatment of accounts or activities. Moreover, users may have preferences regarding the treatment of such accounts or activities. As a result, the system may contain the capability to tag certain accounts or activities based on both jurisdictional and user requirements. The present invention may intelligently route these tagged accounts or activities to particular calculation engines, or provide for separate storage and retrieval.

Outputs of the system may include data relating to individual jurisdictions, product lines or companies as a whole. Monitoring of both data and regulatory changes may be implemented pursuant to user preference. Furthermore, the present invention may allow a user to maintain and process data through a visual allocation engine, which sets forth categories, targets and process steps. This visual allocation engine may provide a visual intelligence to guide a user through the system.

Other features of the system include the ability to operate outside the current accounting cycle and apportion on a plurality basis. Options to test data in past or future accounting cycles allow users to review past deductions and to adjust current period tax depreciation as well as forecasted tax depreciation. The ability to report or apportion on a plurality basis provides more flexibility to a user and allows for more complicated business structures and calculations.

Although the medium in which the system can be used has been described in a limited manner, the present invention may be implemented using a variety of means. As depicted in the exemplary embodiments, the present invention may be implemented by a microprocessor or the internet. Moreover, the system may be carried out through a computer network, used within other types of data-exchange media or protocols, or performed on multithreaded applications. The volume of information processed, combined with the speed at which the information must be processed, makes the use of a computer advantageous. The computer system will typically have a processor, such as central processing unit (CPU), where the processor is linked to a memory, an input, and an output. A computer or computer network may include several other components as well. For example, the memory components may include a hard disc for non-transitory storage of information, as well as random access memory (RAM). The input components may include a keyboard, a touchscreen, a mouse, and a modem for electronic communication with other devices. The output components may include a modem, which may be the same modem used for the input or a different one, as well as a monitor or speakers. Many of the different components may have varying physical locations, but they are still considered a computer or computer network for purposes of this description. For example, the memory may be on a hard drive in the same physical device as the processor, or the memory component may be remotely located and accessed as needed using the input and output. The memory may also have one more programs to carry out the functions described previously. The memory components may also have one or more databases along with related data.

In summary, the present invention of a system and method for calculating, analyzing and tracking regulatory recovery for business accounts and activities has at least the following advantages:
providing an automated process to perform complex calculations, such as the determination of whether an asset may qualify as current repair deductions or whether it must be capitalized and depreciated;
providing a database which is automatically updated with retirement information so that current and future tax calculations can be performed more accurately;
providing the ability to tag specific data so that it may be treated differently with regard to tax calculations and regulatory requirements;
providing the visual capability to guide a user through the tax calculation or regulatory accounting process; and
providing the capability to perform accounting calculations and supply reports with regard to specific jurisdictional or other requirements in a single system.

While the invention has been described with respect to a limited number of embodiments, those skilled in the art, having benefit of this disclosure, will appreciate that other embodiments can be devised which do not depart from the scope of the invention as disclosed here.

What is claimed is:

1. A system for calculating, analyzing and tracking regulatory recovery relating to regulatory management, comprising:
a. a mapping interface for mapping the source data from multiple source databases;
b. analysis keys that are applied and act as data tags to the mapped source data;
c. a storage database for storing the mapped source data;
d. a jurisdictional template for filtering mapped source data in order to model the data for a specific jurisdiction;
e. a case ledger layer that generates rate cases based on filtered mapped source data;
f. a regulatory monitoring tool that monitors regulatory recovery performance;
g. a revenue requirements manager that analyzes both historical and forecast rate cases; and
h. a user report generated from the regulatory monitor and revenue requirements manager.

2. The method of claim 1, where one of the source databases comprises a charge repository.

3. The method of claim 1, where one of the source databases comprises a capital database.

4. The method of claim 1, where one of the source databases comprises an external database to the system.

5. The method of claim 1, further comprising a visual allocator that creates a graphic display for manipulation of mapped source data.

6. The method of claim 1, where the jurisdictional template has a manual override capability.

7. A method for calculating, analyzing and tracking regulatory recovery relating to regulatory management, comprising:
a. mapping source data from multiple source databases with a mapping interface;
b. applying analysis keys to the mapped source data, where the analysis keys act as data tags;
c. storing mapped source data in a storage database;
d. filtering the mapped source data through a jurisdictional template to model the data for specific jurisdictional considerations;
e. creating a separate rate case from the filtered data with a revenue requirements manager; and
f. compiling a user report on the accounts from the separate rate case.

8. The method of claim 7, where the separate rate case is analyzed from historical rate cases by the revenue requirements manager.

9. The method of claim 7, where the separate rate case is analyzed from forecast rate cases by the revenue requirements manager.

10. The method of claim 7, further comprising displaying the mapped source data on a visual allocator for user manipulation.

11. The method of claim 7, where the regulatory for a jurisdiction is monitored by regulatory monitoring tool.

12. The method of claim 7, where changes to regulatory filing requirements for a jurisdiction are monitored by regulatory monitoring tool.
